(19) United States
(12) Patent Application Publication
(10) Pub. No.: US 2023/0245138 A1
(43) Pub. Date: Aug. 3, 2023

(54) SYSTEMS AND METHODS FOR AUTHENTICATING ONLINE SALES USING MACHINE LEARNING

(71) Applicant: LANCE TROH, Seymour, CT (US)

(72) Inventor: LANCE TROH, Seymour, CT (US)

(21) Appl. No.: 18/103,481

(22) Filed: Jan. 30, 2023

Related U.S. Application Data
(60) Provisional application No. 63/304,988, filed on Jan. 31, 2022.

(51) Int. Cl. G06Q 30/018; G06F 16/951

(52) U.S. Cl. CPC G06Q 30/0185; G06F 16/951

(57) ABSTRACT

Systems and methods of verifying the authenticity of shoes on websites. Methods include receiving user input for a shoe type and size, and retrieving from a first database recommended shoes that match the user input. Embodiments further include receiving a URL to a website from a second user input where the shoe to be authenticated is resides, fetching data from the website where the authenticated shoe resides including HTML, Javascript, and CSS pages used in creating the webpage, storing the fetched data in a second database, and extracting a set of comparison data from the fetched data. Embodiments further include gathering and training one or more machine learning algorithms which are used as input for the authentication and confirmation.

### CROSS-REFERENCE TO RELATED APPLICATIONS

The present application claims priority to provisional patent application 63/304,988, filed on Jan. 31, 2022.

### BACKGROUND

Many consumers enjoy purchasing unique or limited edition shoes or clothing online. While there are many options for purchasing such goods which often carry a more expensive price tag, there are limited ways to knowing whether the goods are actually authentic. Fake designer clothing and shoes carries a marketplace that is in the billions of dollars. Most sites which present these designer shoes and goods have limited technical capabilities of deciding or indicating whether the potential sale is a fake one. There is a need, therefore, for more fast, accurate and automatic methods of authenticating purchases online for consumers in the clothing and footwear industries.

### BRIEF SUMMARY

In one aspect, a method of verifying the authenticity of shoes on a website, includes receiving user input for a shoe type and size, retrieving from a first database recommended shoes that match the user input, receiving a URL to a website from a second user input where the shoe to be authenticated is resides, fetching data from the website where the authenticated shoe resides including HTML, Javascript, and CSS pages used in creating the webpage, storing the fetched data in a second database, extracting a set of comparison data from the fetched data, comparing the set of comparison data with data in the first database, determining if the set of comparison data matches the data in the first database based on a set of metrics, when the set of comparison data matches the data in the first database indicating to the user that the shoes on the website are authentic, and when the set of comparison data does not match the data in the first database, presenting the user with a further authentication.

The method may also include determining if the description and title from the comparison data matches words in a set of words in the set of metrics, and when the description and title from the comparison data does not match words in the set of words, indicating the website as invalid. Other technical features may be readily apparent to one skilled in the art from the following figures, descriptions, and claims.

The method may also include determining if the price of the shoe in the comparison data is lower than a price threshold in difference from the price in the set of metrics in the first database, and when the price of the shoe in the comparison data is lower than the price threshold in difference, indicating the website as invalid.

The method may also include determining if the website and user account on the website are part of a set of keywords, and when the website or user account are part of a set of keywords, indicating the website as invalid.

The method may also include wherein the set of keywords includes ratings of the seller on the website including their reviews, and verified profile status.

The method may also include wherein the set of keywords includes the extent of the account history and the number of items sold for that account.

The method may also include wherein the set of keywords includes the selling history and the price and nature of the recent items sold by the seller. Other technical features may be readily apparent to one skilled in the art from the following figures, descriptions, and claims.

### BRIEF DESCRIPTION OF THE SEVERAL VIEWS OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates a System Environment in accordance with some implementations.

FIG. 2 illustrates a Machine Learning algorithm routine in accordance with some implementations.

FIG. 3 illustrates a fraud detection routine in accordance with some implementations.

FIG. 4 illustrates an exemplary Artificial Neural Network in accordance with some implementations.

FIG. 5 is an example schematic diagram of a system in accordance with some implementations.

FIG. 6 illustrates an item size UI in accordance with some implementations.

FIG. 7 illustrates a URL input UI in accordance with some implementations.

FIG. 8 illustrates an image input UI in accordance with some implementations.

FIG. 9 illustrates a Failed Authentication UI in accordance with some implementations.

FIG. 10 illustrates a successful Authentication UI in accordance with some implementations.

FIG. 11A illustrates an aspect of the UI in accordance with one embodiment.

FIG. 11B illustrates an aspect of the UI in accordance with one embodiment.

FIG. 12 illustrates an example architecture 1200 for implementing a fraud detection system according to some embodiments.

FIG. 13 illustrates a cloud computing environment.

FIG. 14 illustrates a set of functional abstraction layers provided by cloud computing environment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Computer manufacturers have been struggling for years to make fast, efficient and accurate methods of authenticating third party sales online. Embodiments of the present invention include methods and systems for using Machine Learning algorithms, and automated steps toward authenticating purchases online such that the processing power of the computers and systems involved is vastly improved.

In some embodiments users can submit shoes or footwear details they wish to be authenticated in a command line or web interface. The system may retrieve from an authentication database data to auto-populate the search query with recommended shoes, footwear or clothing based on size, description, item name, etc. The authentication database may include authenticated information for clothing or shoes including item name, color, description, release date, retail price, style ID, image links, product links from resell sites, and one or more price maps from authenticated resell sites. When the item is selected from the auto-populated list, the authentic information is retrieved for comparison to the sale site. The user may then present a link or URL to the potential sale site.

The system may fetch all of the data from the potential sale site including any HTML, Javascript, or CSS information and store it in a comparison database. The data which has been fetched may also be stored as inputs to one or more Machine Learning (ML) algorithms to improve the results and learning of the ML algorithm. Comparison data may then be extracted from the fetched data. Comparison data may include descriptions, titles, pricing information, keywords used, user account ratings, account sale history, nature of selling history, etc. that is withdrawn from the fetched data. Exemplary keywords may be used such as:
UA
1000%
Replicate
Reps
Unauthorize
Unauthorized
Fake
Factory
Manufacture

Next the system may go through a series of comparisons. The comparisons may be done in any sequence, at any stage when a fail is determined the user may be presented with a notice that the site or sale is not authentic. For example, the description and title of the fetched data may be compared with data from the authentication database. When the description and/or title do not match, or differ by a certain percentage, a fail may be returned and the user presented with a notification that the site is not authentic. Next, the price may be compared to the authentication database, and when the price is determined to be different based on a price threshold, a fail may be returned, and the sale site presented to the user as inauthentic. Next a keyword comparison may be performed based on learned keywords from the Machine Learning algorithm. When certain keywords are present the site/sale may be indicated as inauthentic. Finally, account information or sales history and/or known blocked websites may be checked returning a result of pass and/or fail.

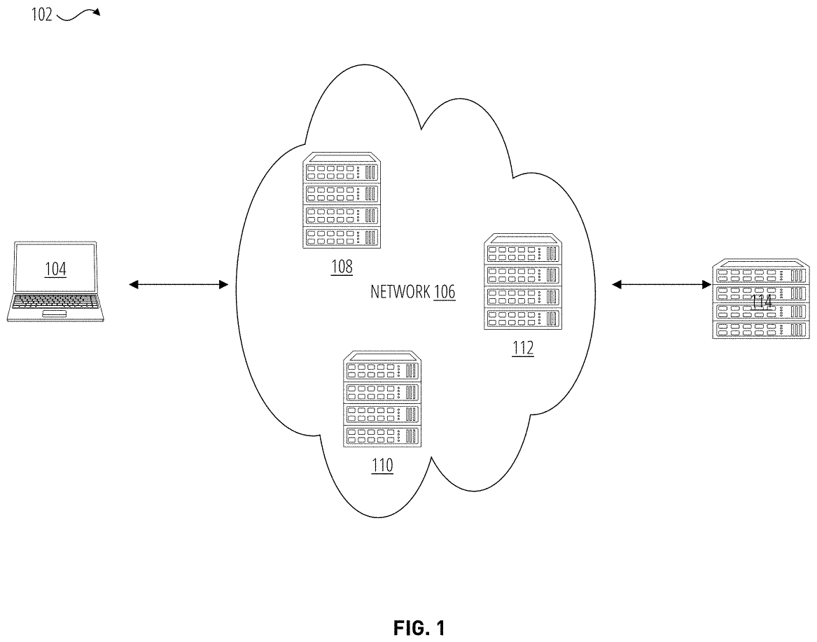

FIG. 1 illustrates a System Environment 102 in accordance with some implementations. The System Environment 102 comprises a User Device 104, a Network 106, Cloud servers 108-112, and a Site Server 114. The User Device 104 may be a tablet, a personal computer, a smartphone, a server, etc. used by the user for accessing sites for the sale of shoes on Site Server 114. Site Server 114 may be a server hosting one or more sales of shoes for legitimate sale such as Amazon™ or Mercari. Similarly, Site Server 114 may be a fraudulent site hosting the sale of shoes. The Network 106 may be, but is not limited to, a wireless, cellular or wired network, a local area network (LAN), a wide area network (WAN), a metro area network (MAN), the Internet, the worldwide web (WWW), similar networks, and any combination thereof. Cloud servers 108-112 may be one or more network or routing servers or datacenters used to store user information and manage and upload Machine Learning data. Cloud servers 108-112 may also include one or more databases including authenticated sites, shoes, keywords, titles, etc. Cloud servers 108-112 may also include one or more additional databases including information from downloaded sites such as their Hyper Text Markup Language (HTML) code, Javascript or other scripting languages, and Cascading Style Sheets (CSS) code. Any other or additional internet retrieved data may be considered and is within the scope of the present invention.

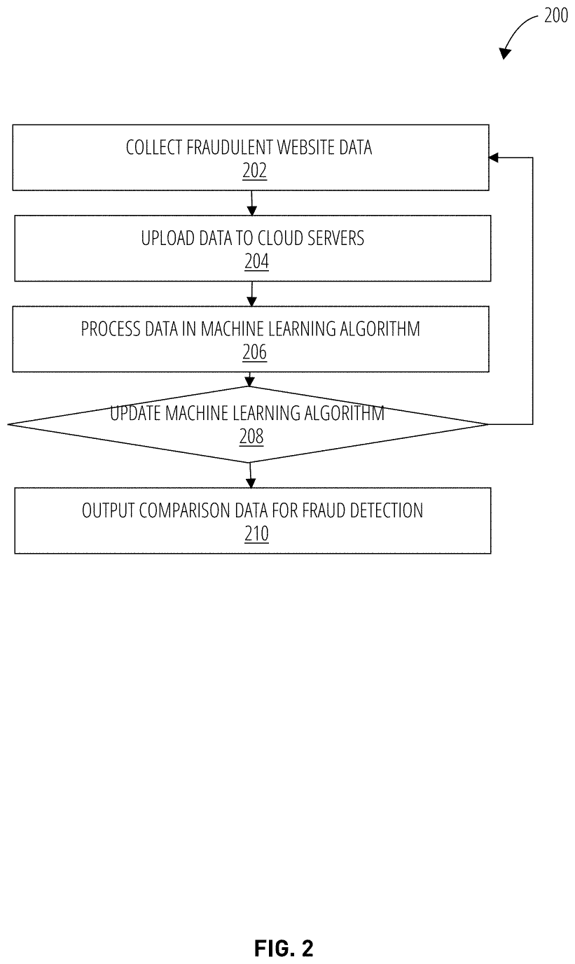

FIG. 2 illustrates a Machine Learning algorithm routine 200 in accordance with some implementations. In block 202, routine 200 collects fraudulent Website data. Website collecting as well as fetching of data may be used in this process. Web indexing, web mining, and data mining procedures may take place to gather all or part of the fraudulent website data. For example, one or more web crawlers may be used which parse one or more lists of Uniform Resource Locator (URL's) or web addresses. The crawler program may traverse the web URL's one by one and access and download some or all of the information including the text, as well as the HTML, CSS, Javascript, etc.

The data retrieved may be stored on one or more of the databases of cloud servers 108-112 as mentioned. The crawler(s) may use one or more techniques such as URL normalization including path-ascending crawling, focused crawling, semantic focused crawling, etc. In some examples, well known sites of fraudulent data may be known and be input to the crawlers to gather data for input into the Machine Learning algorithm(s). In other embodiments, a presorted or pre-collected series of fraudulent data or websites may be collected and input into routine 200.

As the data is collected it also may be parsed by one or more algorithms searching for fraudulent terms and phrases. One or more parser or scraper Application Programming Interfaces (API's) may be used in the process. Similarly, Document Object Model (DOM) parsing techniques may be used analyzing specific tags, identifiers, and elements of the DOM for terms used in fraudulent website data.

Additionally, vertical aggregation, semantic annotation recognition and computer vision web-page analysis may be used in identifying and extracting the information and data used to be input into the Machine Learning models and algorithm(s). The data submitted by the user for fraud verification in routine 300 may be used to supplement, train, and improve the Machine Learning algorithms.

In block 204, routine 200 uploads data to Cloud servers 108-112. The Machine Learning process may be performed on one or more cloud servers. The data may be submitted to one or more cloud servers for distributed processing. In some embodiments, the Machine Learning may be performed on one centralized server or at an individual datacenter. The upload of data may occur all at once, or over time, as more data is collected or gathered. The data may be transmitted using an HTTP REST API, for example, or no upload may take place when the Machine Learning algorithm occurs on the same server/servers as the data collection itself.

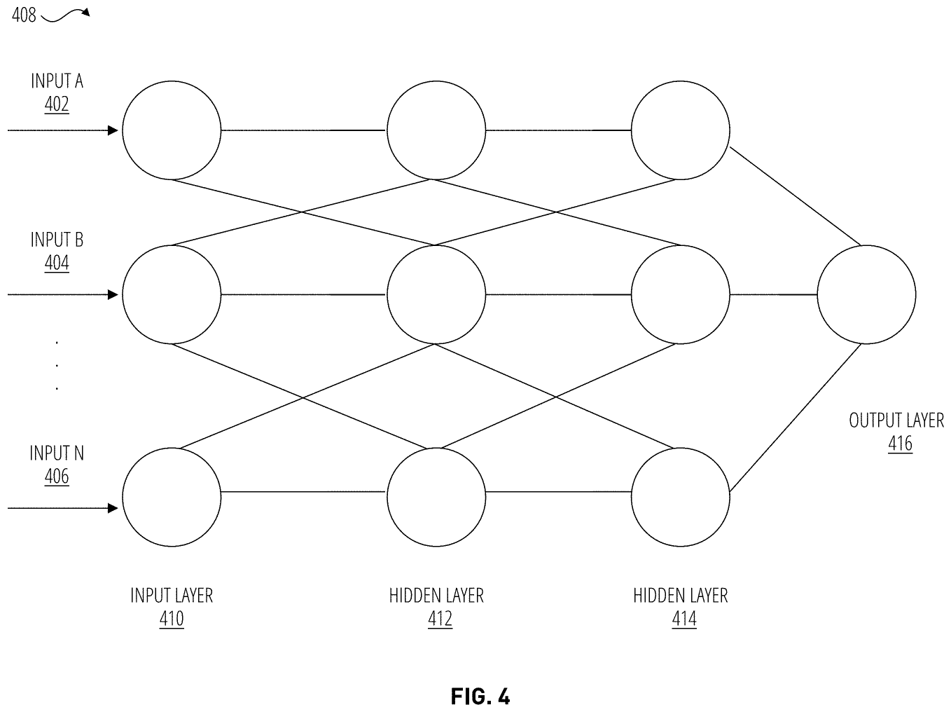

In block 206, routine 200 processes data in one or more machine learning algorithms. Exemplary machine learning algorithms include decision trees, regression analysis, neural networks, time series algorithms, clustering, outlier detection algorithms, ensemble models, factor analysis, naïve Bayes, and support vector machines, for example. As illustrated in FIG. 4 an Artificial Neural Network may be used with various fraudulent data samples input. The processing of the machine learning algorithm may include training of the system with the collected or parsed fraudulent data, and further validation and testing.

In decision block 208, routine 200 updates the machine learning algorithm(s). Any of the data input to the Machine Learning algorithm may be used to update the system. For example, user behaviors may be identified in web collected data such as closing of accounts, frequency of opening new accounts across the internet or on a specific website. Pricing data for particular shoes can be used to predict fraudulent activity. For example, when a website is using pricing for a particular shoe a threshold may be created indicating enough fraudulent sites selling that particular shoe for that lower price. Wording and Natural Language Processing (NLP) may be used to update keywords often used on fraudulent sites, misspellings, grammar mistakes or text patterns etc.

In other embodiments, ratings, reviews and profile statuses may be used to accumulate or train the Machine Learning algorithm to understand and predict which users are more likely to be false. Similarly, account history of sellers and numbers of items sold may be input to the Machine Learning algorithms for prediction of likelihoods of falsehood. Similarly frequently used words may be accumulated via Machine Learning to be input as keywords for predicting likelihood of fraudulent sales. Selling history, price, and type or nature of recent sold items may be indicators of false or true sellers.

In block 210, routine 200 outputs one or more sets of Comparison data for fraud detection to be used in routine 300. Based on the data input discussed, the updating and the outputs of the Machine Learning algorithms are one or more sets of comparison data which may be generated for use in routine 300 of fraud detection. Examples of data used in fraud detection include descriptions, titles, word sets, shoe price, keywords, ratings, reviews, profile statuses, account histories, nature and number of items sold, etc.

For example, a listing of many common used descriptions or terms may be output as comparison data. Further, shoe prices for particular shoes, years of shoes, models of shoes, etc. may be output as comparison data. Similarly, an analysis of incorrect ratings such as an average of one star out of five, or two stars out of five may indicate a fraudulent source. Similarly, a threshold for account histories may be determined to be at least 3 years, or 4 years old as legitimate while many accounts with less than one year or a few months may be determined to be fraudulently detected sources. Additional comparison data may include none or under five or ten items sold on an account selling shoes.

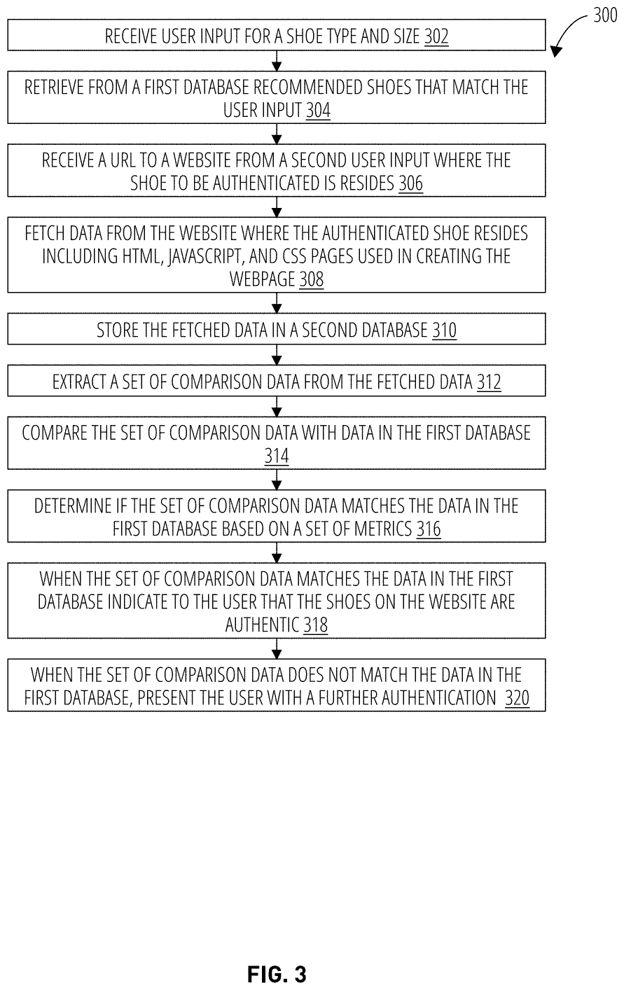

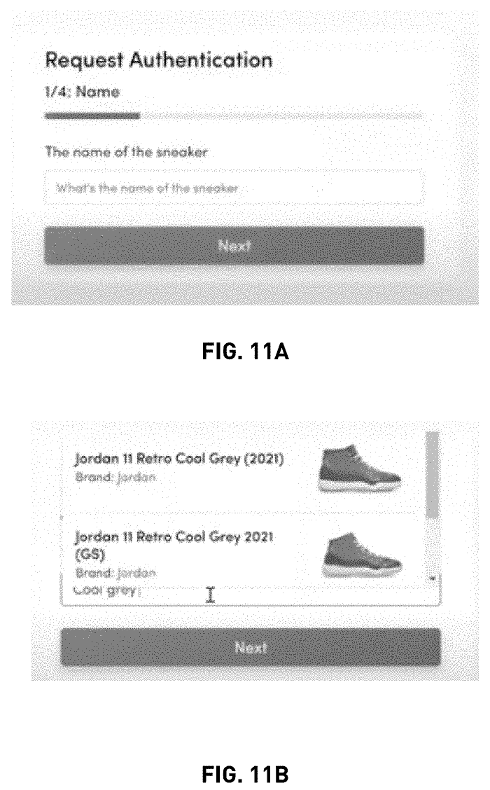

FIG. 3 illustrates a fraud detection routine 300 in accordance with some implementations. In block 302, routine 300 receives user input for a shoe type and size. The user may input into a web interface or command line data related to their shoes or apparel as illustrated in FIG. 11A.

In block 304, routine 300 retrieves from a first database recommended shoes that match the user input. The system may access one or more authentication databases which contain verified information related to item pricing, names, brands, descriptions, original manufacture or sale date, etc. The system may access the authentication databases (herein, first database) and automatically populate the field to make recommendations to the user for suggestions identifying the shoe or apparel they are trying to search for as illustrated in FIG. 11B. Once the correct or identified item is selected, the system may proceed to block 306.

In block 306, routine 300 may receive a Uniform Resource Locator (URL) to a website from a second user input where the shoe or apparel to be authenticated is resides. In another embodiment, a screenshot may be input to the system. In yet another embodiment, a user may fill out information related to the potentially fraudulent sale. The input to the system may include title, seller, account information of the seller, price, images used, description, selling history, etc. The user may directly input a web address or full URL addressed to the item sale which is trying to be authenticated.

Next, in block 308, routine 300 fetches data from the website where the authenticated shoe or apparel resides including HTML, Javascript, and CSS pages used in creating the webpage. The data accessed from the URL may be indexed, mined, etc. using Document Object Model (DOM) parsing Natural Language Processing. All of the files associated with the site may be retrieved during this step. HTML tags may be analyzed and searched for particular information such as price, ratings, reviews, account history, user ID's, etc. Machine learning elements of FIG. 2 may be used in the fetching and analysis of this data.

In block 310, routine 300 stores the fetched data in a second database. The fetched data may be stored in the comparison database or second database. The data may be stored redundantly across multiple cloud nodes, Virtual Machines (VM's), servers, etc.

In block 312, routine 300 may extract a set of comparison data from the fetched data. The set of comparison data may include the price of the items for sale, the ratings or reviews of the account holder, the account history, the selling history, the descriptions of the items for sale, etc. The extraction may be done using Machine Learning techniques as well as HTML tags or HTML ID searches. For example, a “price” tag or identifier may be used to find the price within the pages.

In block 314, routine 300 compares the set of comparison data with data in the first database. Comparing the data in the authentication database with the data in the comparison database may include any of several comparisons and be done in any order. The following comparisons may be done:
Title and description against one or more sets of keywords. The keywords may be generated by the Machine Learning algorithms.
   Exemplary base keywords may be, for example: UA, 1000%, Replicate, Reps, Unauthorize, Unauthorized, Fake, Factory, Manufacture
Price comparison of the sale site versus the authenticated price. Comparison of the price versus a threshold difference may be done such as 5%, 10%, 20%, etc.
Blocked sites and/or blocked user profiles. A listing may be generated of blocked sites based on the Machine Learning outputs as well as user profiles with fraudulently indicated products.
Keyword comparisons with words used in the selling site. Example keywords include things such as a return policy, premium quality, etc.
Ratings, reviews, verified profiles.
Account history, example accounts with less than 6 months of history may be considered inauthentic.
Selling history including what items have recently been sold.

In some implementations, the title and description may be compared against a set of inauthentic keywords. When any of the keywords are matched a fail may be returned. Next the price from the fetched site may be compared against the authentication database's price. When the price is lower than 15% of the price in the authentication database then a fail returns. When the price comparison passes the site may be compared against a list of fraudulent sites. If the site is found on the list the test may fail. Finally, a set of keywords may be compared for ratings of the users. When the rating is lower than 3 stars out of 5, for example, the test may return fail.

In another embodiment, the keyword authentication may be performed first. The account history may be compared against one or more sets set of keywords. When the account history has one of the keywords, the account may be considered fraudulent and a fail is returned. Next the rating may be compared. Ratings comparisons may include determining whether a profile is verified by the site. Similarly, the reviews may be processed using NLP and determined whether authentic based on the Machine Learning output. The description and/or title may be compared in the second step against the keywords. When all the previous steps pass verification, the price may be compared against the price in the authentication database. At any step if the site is considered to be inauthentic the UI may take the user to one or more administrator panels for further verification.

In yet another embodiment, the price may be compared first against one or more thresholds. The threshold may be 25% of the price in the authentication database, for example. When the price is lower than 25% difference then the user may be notified that the sale on the site inauthentic. In the second step one or more sets of keywords may be compared against the rating, account history and/or any previous selling history. The ratings may have the reviews and profiles processed for use of certain keywords. Finally, the description and title may be verified using keywords.

In block 316, routine 300 determines if the set of comparison data matches the data in the first database based on a set of metrics. Using input from the trained Machine Learning algorithms, the system may use one or more criteria in block 314 to determine whether the site is fraudulent or not.

In block 318, when the set of comparison data matches the data in the first database the system indicates to the user that the shoes on the website are authentic. When the comparison data from block 314 is all verified, the user may be notified by an indication on screen or a confirmation page that the sale is authentic.

In block 320, when the set of comparison data does not match the data in the first database, presents the user with a further authentication. When any of the comparison data from block 314 is determined to be inaccurate, the system may automatically transfer the user to an administrative panel for further verification. In some embodiments, one or more manual investigations may be made to verify the authenticity of the sale site.

FIG. 4 illustrates an exemplary Artificial Neural Network 408 in accordance with some implementations. Artificial Neural Network 408 may be one or more artificial neural networks as illustrated. Artificial Neural Network 408 is an exemplary neural network which may include any number of inputs such as Input A 402-Input N 406. Similarly, any number of layers or structures of layers may be used such as illustrated with Input Layer 410, Hidden Layer 412, Hidden Layer 414, and Output Layer 416. In one example, Input A 402 may take as input the price of shoes. Input B 404 may take profile statuses or account histories. Similarly Input N 406 may take as input descriptions or keywords.

In some examples, the Artificial Neural Network 408 may be used during learning on the group data in step 206 and/or step 208. In other embodiments, an Artificial Neural Network 408 may be used during block 310-block 316, for example. In some embodiments, each of the inputs may be weighed according to the relevant activation function, number of hidden layers, various interconnection combinations, etc.

In some embodiments, Artificial Neural Network 408 may be one of many different Artificial Neural Network's (ANN) used, each for different groupings of data. Examples of data to be used as inputs, includes
Title and description
Price
Thresholds for comparison
Blocked sites or blocked profiles
Keywords
Ratings
Reviews
Profiles
Account histories
Selling history

In some embodiments, Artificial Neural Network 408 may be stored on Cloud servers 108-112 and/or User Device 104.

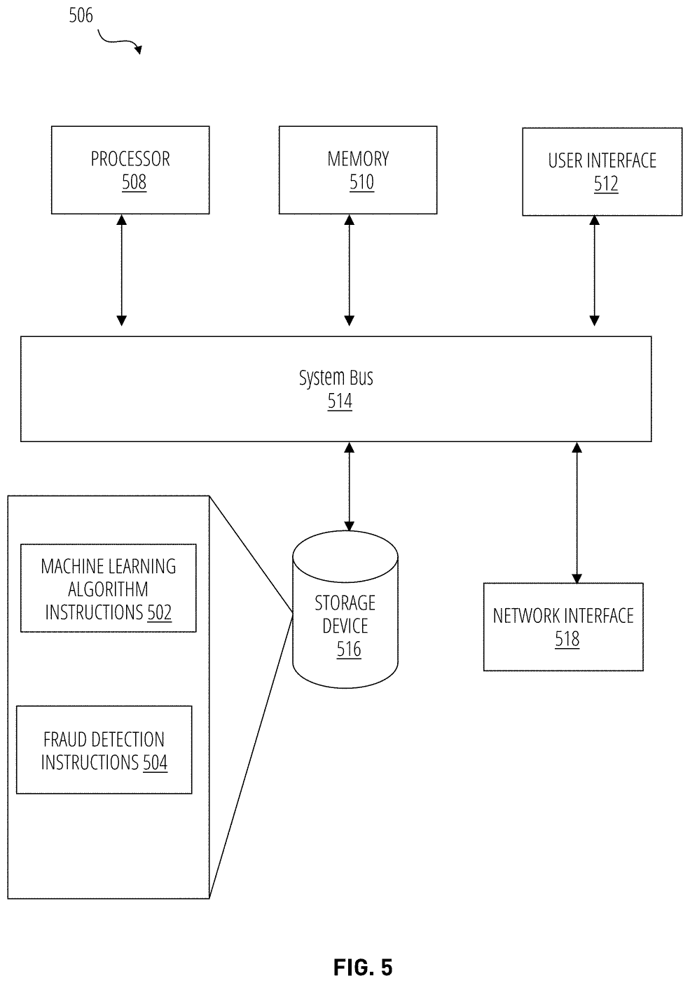

FIG. 5 is an example schematic diagram of a system 506 according to an embodiment. The system 506 includes a Processing Circuitry 508 coupled to a memory 510, a Storage Device 516, and a network interface 518. In an embodiment, the components of the system 506 may be communicatively connected via a System Bus 514.

The Processing Circuitry 508 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 510 may be volatile (e.g., RAM, etc.), non-volatile (e.g., ROM, flash memory, etc.), or a combination thereof. In one configuration, computer readable instructions to implement one or more embodiments disclosed herein may be stored in the storage Storage Device 516. One or more sets of Machine Learning Algorithm Instructions 502, and/or Fraud Detection Instructions 504, may be stored on Storage Device 516. Machine Learning Algorithm Instructions 502 may be used to implement the method of routine 200 and update one or more Machine Learning databases such as Artificial Neural Network 408. Fraud Detection Instructions 504 may be used to implement routine 300, for example and detect fraud of sales of shoes on various websites.

In another embodiment, the memory 510 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the Processing Circuitry 508, cause the Processing Circuitry 508 to perform the various processes described herein. Specifically, the instructions, when executed, cause the Processing Circuitry 508 to create, update and manage Machine Learning algorithms, and process and detect fraudulent sale of shoes.

The Storage Device 516 may be magnetic storage, optical storage, and the like, and may be realized, for example, as flash memory or other memory technology, CD-ROM, Digital Versatile Disks (DVDs), or any other medium which can be used to store the desired information.

The network interface 518 allows the system 506 to communicate with the Cloud servers 108-112 for the purpose of, for example, receiving data, sending data, and the like. Further, the network interface 518 allows the system 506 to communicate with the Cloud servers 108-112. It should be understood that the embodiments described herein are not limited to the specific architecture illustrated in FIG. 5, and other architectures may be equally used without departing from the scope of the disclosed embodiments.

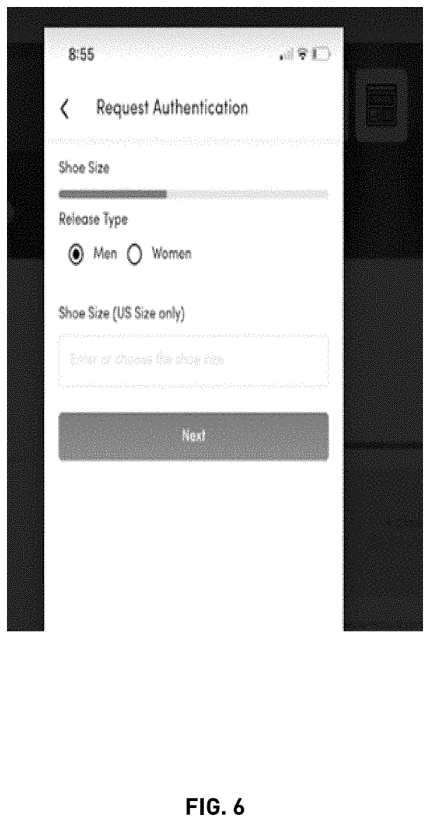

FIG. 6 illustrates an item size UI in accordance with some implementations. As illustrated, the user may request authentication indicating the size and gender identifier for the item such as a shoe. A popup may be presented allowing the user to select the item size.

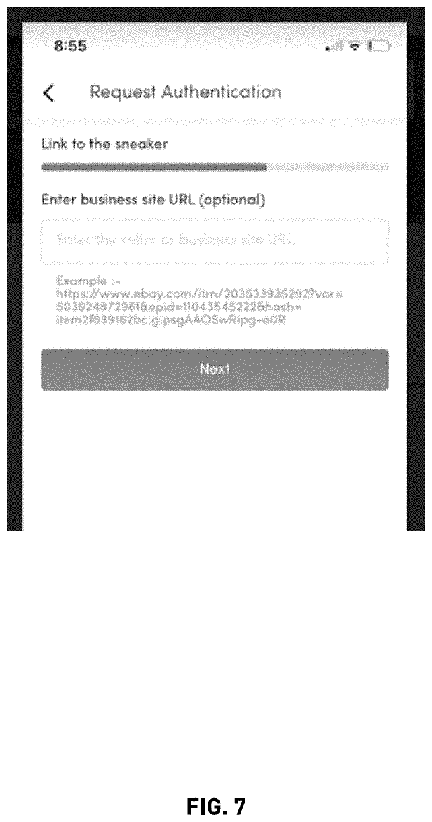

FIG. 7 illustrates a URL input UI in accordance with some implementations. The user may be prompted to input the URL or site address to where the intended purchase is going to be made. The user may input the whole URL or numeric address to indicate what images, data and files should be downloaded for analysis and Machine Learning input.

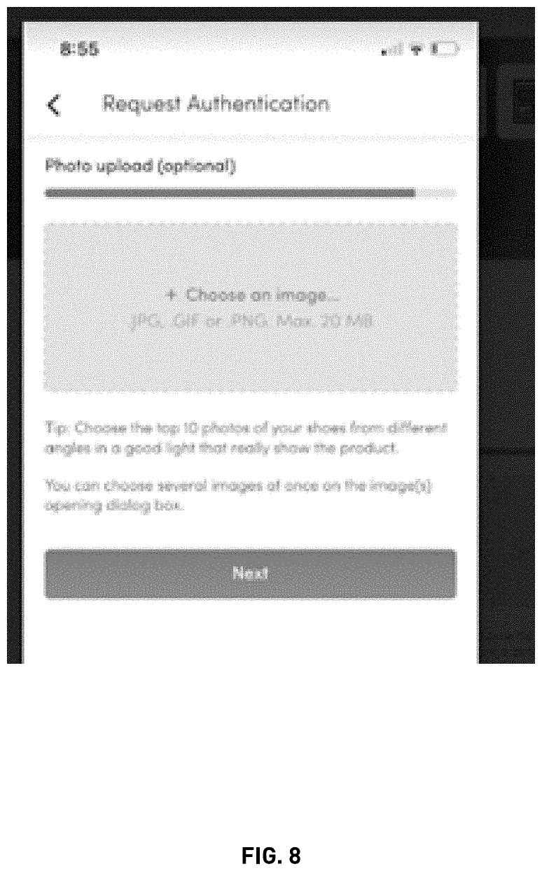

FIG. 8 illustrates an image input UI in accordance with some implementations. As illustrated, the user may input one or more images of the items for image analysis and Machine Learning input. The image may be compared to stock images for example, of an item. If someone is selling a used or second hand item and they post a stock image used by the OEM that may be an indicator of false sale pretenses.

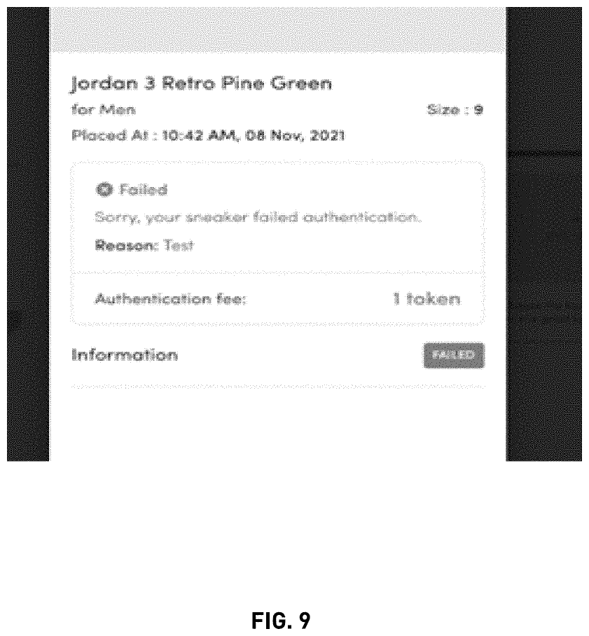

FIG. 9 illustrates a Failed Authentication UI in accordance with some implementations. As illustrated the user may be presented with one or more UI's indicating that the authentication has failed. This may be presented at any stage of the authentication or verification process.

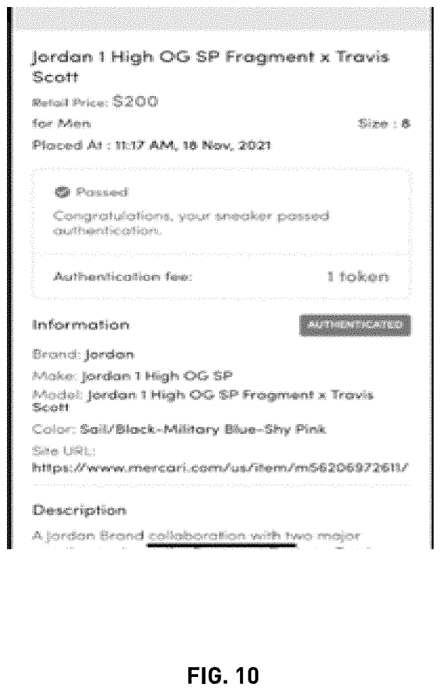

FIG. 10 illustrates a successful Authentication UI in accordance with some implementations. The user may be presented with one or more similar UI's when the authentication has been verified and all of the steps returned success.

FIG. 11A illustrates an aspect of the UI in accordance with one embodiment.

FIG. 11B illustrates an aspect of the UI in accordance with one embodiment.

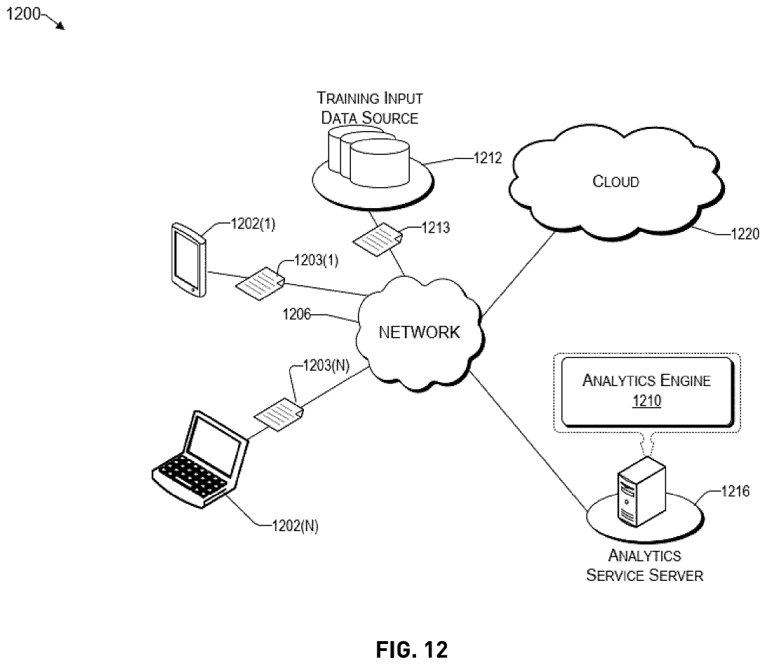

FIG. 12 illustrates an example architecture 1200 for implementing a fraud detection system according to some embodiments. Architecture 1200 includes a network 1206 that allows various computing devices 1202(1) to 1202(N) to communicate with each other, as well as other elements that are connected to the network 1206, such as a training data source 1212, an analytics service server 1216, and the cloud 1220.

The network 1206 may be, without limitation, a local area network (“LAN”), a virtual private network (“VPN”), a cellular network, the Internet, or a combination thereof. For example, the network 1206 may include a mobile network that is communicatively coupled to a private network, sometimes referred to as an intranet that provides various ancillary services, such as communication with various application stores, libraries, and the Internet. The network 1206 allows the analytics engine 1210, which is a software program running on the analytics service server 1216, to communicate with a training data source 1212 (and training data 1213), computing devices 1202(1) to 1202(N), and the cloud 1220, to provide machine learning capabilities. In one embodiment, the data processing is performed at least in part on the cloud 1220.

For purposes of later discussion, several user devices appear in the drawing, to represent some examples of the computing devices that may be the source of data. Aspects of the fetched website data or user data (e.g., 1203(1) and 1203(N)) may be communicated over the network 1206 with an analytics engine 1210 of the analytics service server 1216. Today, user devices typically take the form of portable handsets, smart-phones, tablet computers, and smart watches, although they may be implemented in other form factors, including consumer, and business electronic devices.

For example, a computing device (e.g., 1202(N)) may send a request 1203(N) to the analytics engine 1210 to perform machine learning on the fetched website data or user data stored in the computing device 1202(N). In some embodiments, there is (one or more) training data source 1212 that is configured to provide training data to the analytics engine 1210. In other embodiments, the fetched website data or user data are generated by the analytics service server 1216 and/or by the cloud 1220 in response to a trigger event.

While the training data source 1212 and the analytics engine 1210 are illustrated by way of example to be on different platforms, it will be understood that in various embodiments, the training data source 1212 and the learning server may be combined. In other embodiments, these computing platforms may be implemented by virtual computing devices in the form of virtual machines or software containers that are hosted in a cloud 1220, thereby providing an elastic architecture for processing and storage.

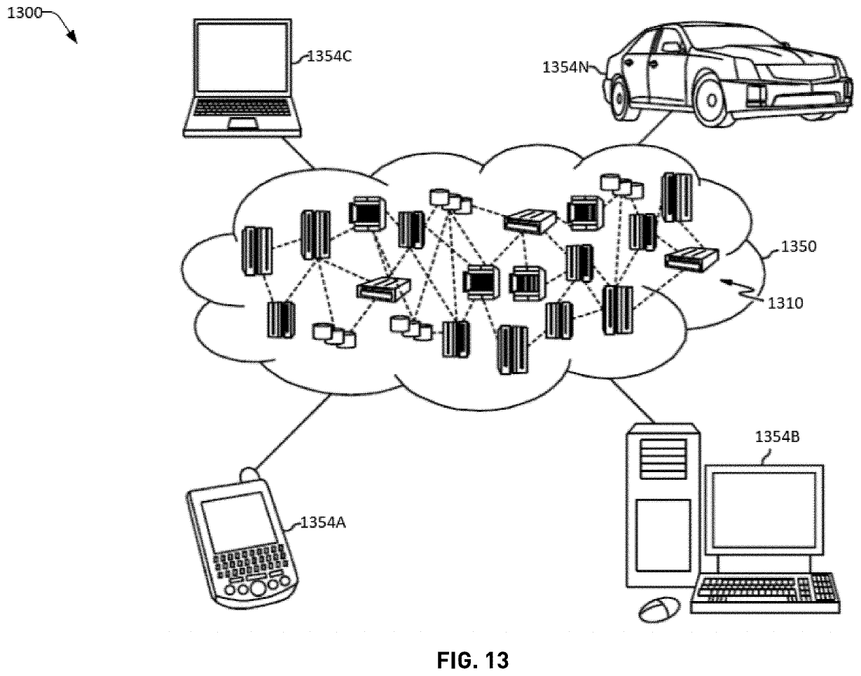

Referring now to FIG. 13, an illustrative cloud computing environment 1300 is depicted. As shown, cloud computing environment 1300 includes one or more cloud computing nodes 1310 with which local computing devices used by cloud consumers, such as, for example, cellular telephone 1354A, desktop computer 1354B, laptop computer 1354C, and/or automobile computer system 1354N may communicate. Nodes 1310 may communicate with one another. They may be grouped (not shown) physically or virtually, in one or more networks, such as Private, Community, Public, or Hybrid clouds as described hereinabove, or a combination thereof. This allows cloud computing environment 1350 to offer infrastructure, platforms and/or software as services for which a cloud consumer does not need to maintain resources on a local computing device. It is understood that the types of computing devices 1354A-N shown in FIG. 13 are intended to be illustrative only and that computing nodes 1310 and cloud computing environment 1350 can communicate with any type of computerized device over any type of network and/or network addressable connection (e.g., using a web browser).

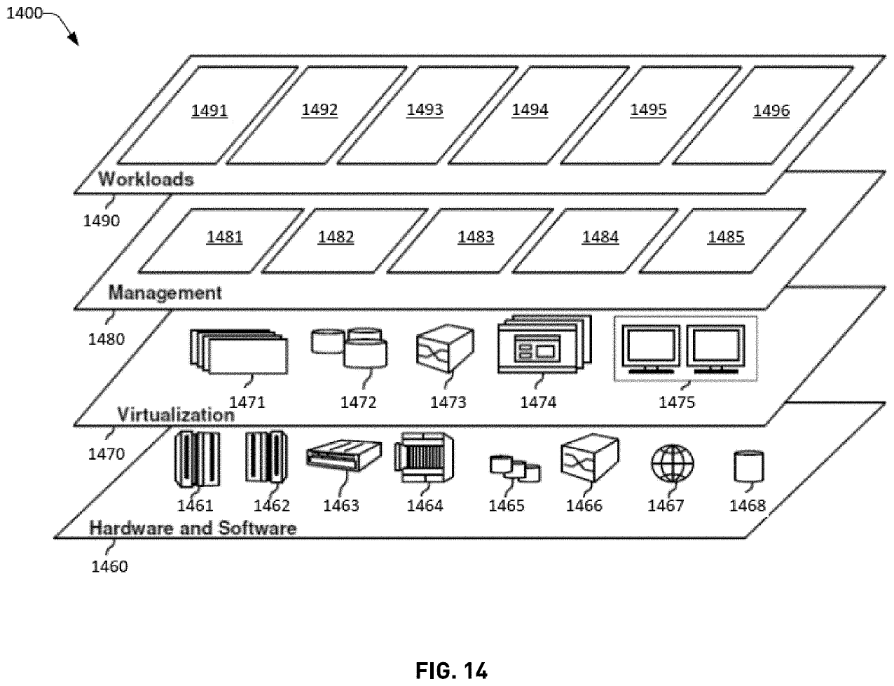

Referring now to FIG. 14, a set of functional abstraction layers provided by cloud computing environment 1350 (FIG. 13) is shown. It should be understood in advance that the components, layers, and functions shown in FIG. 14 are intended to be illustrative only and embodiments of the disclosure are not limited thereto. As depicted, the following layers and corresponding functions are provided:

Hardware and software layer 1460 includes hardware and software components. Examples of hardware components include: mainframes 1461; RISC (Reduced Instruction Set Computer) architecture based servers 1462; servers 1463; blade servers 1464; storage devices 1465; and networks and networking components 1466. In some embodiments, software components include network application server software 1467 and database software 1468.

Virtualization layer 1470 provides an abstraction layer from which the following examples of virtual entities may be provided: virtual servers 1471; virtual storage 1472; virtual networks 1473, including virtual private networks; virtual applications and operating systems 1474; and virtual clients 1475.

In one example, management layer 1480 may provide the functions described below. Resource provisioning 1481 provides dynamic procurement of computing resources and other resources that are utilized to perform tasks within the cloud computing environment. Metering and Pricing 1482 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1483 provides access to the cloud computing environment for consumers and system administrators. Service level management 1484 provides cloud computing resource allocation and management such that required service levels are met. Service Level Agreement (SLA) planning and fulfillment 1485 provide pre-arrangement for, and procurement of, cloud computing resources for which a future requirement is anticipated in accordance with an SLA.

Workloads layer 1490 provides examples of functionality for which the cloud computing environment may be utilized. Examples of workloads and functions which may be provided from this layer include: fetching internet data 1491; machine learning training 1492; machine learning applications 1493; data analytics processing 1494; fraud detection 1495; and user interface processing 1496, as discussed herein.

### CONCLUSION

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of verifying the authenticity of shoes on a website, comprising:
receiving user input for a shoe type and size;
retrieving from a first database recommended shoes that match the user input;
receiving a Uniform Resource Locator (URL) to a website from a second user input where the shoe to be authenticated is resides;
fetching data from the website where the authenticated shoe resides including Hyper Text Markup Language (HTML), Javascript, and Cascading Style Sheets (CSS) pages used in creating the webpage;
storing the fetched data in a second database;
extracting a set of comparison data from the fetched data;
comparing the set of comparison data with data in the first database;
determining if the set of comparison data matches the data in the first database based on a set of metrics;
when the set of comparison data matches the data in the first database indicating to the user that the shoes on the website are authentic; and
when the set of comparison data does not match the data in the first database, presenting the user with a further authentication.

2. The method of claim 1 further comprising:
determining if the description and title from the comparison data matches words in a set of words in the set of metrics; and
when the description and title from the comparison data does not match words in the set of words, indicating the website as invalid.

3. The method of claim 2 further comprising:
determining if the price of the shoe in the comparison data is lower than a price threshold in difference from the price in the set of metrics in the first database; and
when the price of the shoe in the comparison data is lower than the price threshold in difference, indicating the website as invalid.

4. The method of claim 3 further comprising:
determining if the website and user account on the website are part of a set of keywords; and
when the website or user account are part of a set of keywords, indicating the website as invalid.

5. The method of claim 4 wherein the set of keywords includes ratings of the seller on the website including their reviews, and verified profile status.

6. The method of claim 4, wherein the set of keywords includes the extent of the account history and the number of items sold for that account.

7. The method of claim 4, wherein the set of keywords includes the selling history and the price and nature of the recent items sold by the seller.

8. The method of claim 1, wherein the comparing and/or determining steps use Machine Learning to compare the comparison data.

9. The method of claim 8, further comprising, training the Machine Learning algorithm by running web crawlers to traverse one or more lists of URL's and parsing the HTML, Javascript and CSS pages to gather data of authentic and inauthentic sales sites, prices, keywords, seller profiles, and reviews of sellers.

10. The method of claim 9, wherein the training occurs on one or more Artificial Neural Networks (ANN), using one or more of the following: decision trees, regression analysis, neural networks, time series algorithms, clustering, outlier detection algorithms, ensemble models, factor analysis, naïve Bayes, and support vector machines.

11. The method of claim 10, wherein the trained ANN outputs data to be used as input for the comparing and determining.

12. The method of claim 11, wherein the data output from the ANN is transmitted using one or more HTTP REST API's between a server where the Machine Learning algorithms and training execute, and the databases.

13. A computing apparatus comprising:
a processor; and
a memory storing instructions that, when executed by the processor, configure the apparatus to:
receive user input for a shoe type and size;
retrieve from a first database recommended shoes that match the user input;
receive a Uniform Resource Locator to a website from a second user input where the shoe to be authenticated is resides;
fetch data from the website where the authenticated shoe resides including Hyper Text Markup Language, Javascript, and Cascading Style Sheets pages used in creating the webpage;
store the fetched data in a second database;
extract a set of comparison data from the fetched data;
compare the set of comparison data with data in the first database;
determine if the set of comparison data matches the data in the first database based on a set of metrics;
when the set of comparison data matches the data in the first database indicate to the user that the shoes on the website are authentic; and
when the set of comparison data does not match the data in the first database, present the user with a further authentication.

14. A non-transitory computer-readable storage medium, the computer-readable storage medium including instructions that when executed by a computer, cause the computer to:
receive user input for a shoe type and size;
retrieve from a first database recommended shoes that match the user input;
receive a Uniform Resource Locator to a website from a second user input where the shoe to be authenticated is resides;
fetch data from the website where the authenticated shoe resides including Hyper Text Markup Language, Javascript, and Cascading Style Sheets pages used in creating the webpage;
store the fetched data in a second database;
extract a set of comparison data from the fetched data;
compare the set of comparison data with data in the first database;
determine if the set of comparison data matches the data in the first database based on a set of metrics;
when the set of comparison data matches the data in the first database indicate to the user that the shoes on the website are authentic; and
when the set of comparison data does not match the data in the first database, present the user with a further authentication.
